(19) United States
(12) Patent Application Publication
(10) Pub. No.: US 2011/0317759 A1
(43) Pub. Date: Dec. 29, 2011

(54) SYSTEM, METHOD, AND COMPUTER PROGRAM PRODUCT FOR PARAMETER ESTIMATION FOR LOSSLESS VIDEO COMPRESSION

(76) Inventors: Vinay S. Thomas, Chandler, AZ (US); Michael Coulter, Chandler, AZ (US)

(21) Appl. No.: 12/823,637

(22) Filed: Jun. 25, 2010

(51) Int. Cl. H04N 7/26; G06K 9/46

(52) U.S. Cl. 375/240.12; 382/168; 375/E07.243

(57) ABSTRACT

Methods and systems to improve the efficiency of video processing. Compression/decompression efficiency for a current frame may be enhanced by using an appropriate coding parameter. To choose an appropriate coding parameter, a histogram of the previous frame's symbols may be created. The histogram may be used to predict the number of bits the current frame will contain after lossless compression, given a specific coding parameter. Iterating through all of the possible coding parameters on the previous frame histogram may yield a well-suited coding parameter with which the current frame can be compressed. This results in high compression efficiency by using the previous frame as the predictor.

### CROSS REFERENCE TO RELATED APPLICATIONS

This application is related to the U.S. patent application entitled “Techniques for Storing and Retrieving Pixel Data,” inventors Vinay Thomas and Michael Coulter, attorney docket no. P33950, U.S. application Ser. No. ______, filed on ______.

### BACKGROUND

When performing video processing, a multimedia system-on-chip (SoC) may have to process multiple video frame buffers within double data rate (DDR) memory. This may result in high DDR bandwidth requirements, driving up cost and power consumption. In these systems, video frame buffers may be written or read at high frame rates by on-chip units such as video capture modules, video decoders, video encoders, 2D or 3D graphics modules, or video display processors. The high bandwidth requirement may be addressed by losslessly compressing these video buffers as they are written to DDR memory and decompressing them as they are read. Such compression and decompression can substantially reduce the DDR bandwidth. However, in order to be practical, any lossless compression process must be able to perform the compression and decompression in real-time without the benefit of pre-processing the current data set.

Existing solutions may perform a simple statistical calculation, i.e. averaging, on the number n of previous symbols to determine the best coding parameter for the current symbol. In the case of Golomb-Rice compression, the parameter may be referred to as M. Other solutions may use an inline filter to choose the coding parameter for the current symbol. These methods may require the previous symbols to be decoded before the coding parameter is available for the current symbol, and thus may not be good candidates for real-time video compression especially as video is streamed in and out of DDR real-time.

### BRIEF DESCRIPTION OF THE DRAWINGS/FIGURES

FIG. 1 is a flow chart illustrating the processing described herein, according to an embodiment.

FIG. 2 illustrates an exemplary histogram of symbols and their frequency of occurrence in a frame, according to an embodiment.

FIG. 3 illustrates a data structure that may be used to store the information of a histogram, according to an embodiment.

FIG. 4 is a block diagram of an exemplary computing environment for a software or firmware embodiment.

In the drawings, the leftmost digit(s) of a reference number identifies the drawing in which the reference number first appears.

### DETAILED DESCRIPTION

A preferred embodiment is now described with reference to the figures, where like reference numbers indicate identical or functionally similar elements. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that this can also be employed in a variety of other systems and applications other than what is described herein.

The methods and systems described herein address the problem of adjusting coding parameters to maximize compression efficiency of a “real-time” lossless video compression scheme. This may be used to reduce DDR memory bandwidth.

Compression/decompression efficiency for a current frame may be enhanced by using an appropriate coding parameter. To choose an appropriate coding parameter, a histogram of the previous frame's symbols may be created. The histogram may be used to predict the number of bits the current frame will contain after lossless compression, given a specific coding parameter. Iterating through all of the possible coding parameters on the previous frame's histogram may yield a well-suited coding parameter with which the current frame can be compressed. This results in high compression efficiency by using the previous frame as the predictor. This exploits the strong correlation between the structure of surrounding frames.

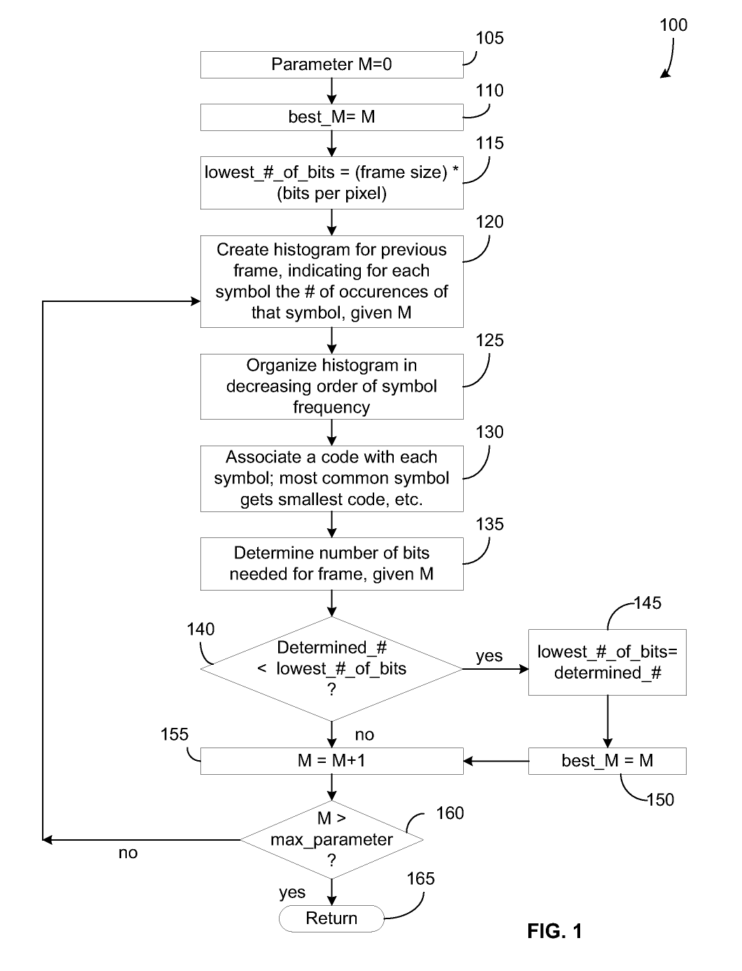

The process by which this may be achieved is illustrated in FIG. 1, according to an embodiment. At 105, a coding parameter M may be initialized to zero. At 110, this value for M is treated, for the moment, as the best known coding parameter, called best_M in the illustrated embodiment. At 115, a variable lowest_#_of_bits may be initialized to the number of bits in the uncompressed current frame, (frame size)*(bits per pixel).

At 120, a histogram may be created for the previous frame. This histogram may indicate, for each symbol, a number of occurrences of that symbol given the coding parameter M. At 125, the histogram may be organized in decreasing order of symbol frequency. The most frequent or common symbol may be shown first, followed by the next most frequent symbol, etc. At 130, a code may be associated with each symbol shown in the histogram. The association of codes may be done by symbol frequency, such that the most common symbol may be assigned to the smallest code, i.e., the code with the fewest number of bits. The next most common symbol may get the next smallest code, etc. At 135, the number of bits needed for encoding the frame may be determined, given the coding parameter M and the codes assigned to the symbols at 130.

At 140, a decision may be made as to whether the number of bits determined at 135 is less than the current value of the variable lowest_#_of_bits. If so, then the process may continue at 145. Here, the determined number of bits may now be assigned to the variable lowest_#_of_bits. At 150, the current coding parameter M may be assigned to the variable best_M. At 155, the coding parameter M may be incremented by one. If, at 140, the number of bits determined at 135 is not less than lowest_#_of_bits, then the current coding parameter M may be incremented by one at 155.

At 160, a determination may be made as to whether M has exceeded the maximum parameter value allowed. If not, then the process may return to 120. Here, another histogram may be created for the previous frame, this time using the newly incremented value for the coding parameter M. The sequence of 120-155 may be repeated for successive values of the coding parameter M. The process may conclude at 165. At this point, the variable best_M contains the coding parameter that is associated with coding the previous frame using the lowest number of bits. The final value for best_M may represent the desired coding parameter.

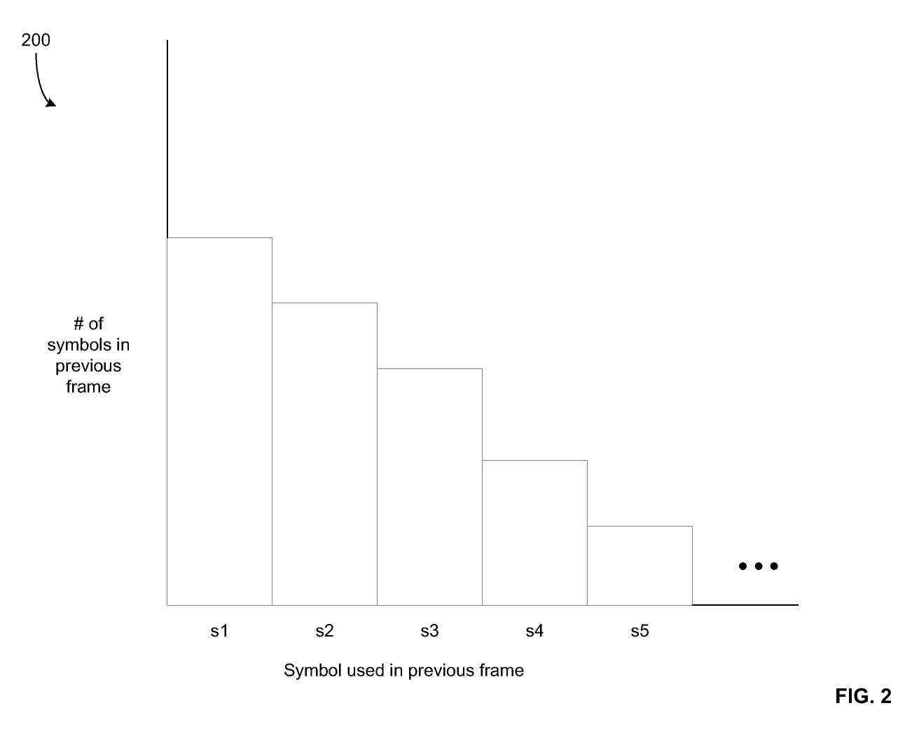

An example of a histogram depicting the frequency of occurrence of symbols in the previous frame is shown in FIG. 2, according to an embodiment. The symbols are shown on the X axis by identifiers s1, s2, . . . etc. The Y axis indicates the number of occurrences of each symbol in the previous frame. In this example, the symbols have been ordered according to the number of times that they appear in the frame. The symbol s1 may be the most frequently occurring symbol, while s2 may be the next most frequently occurring symbol, etc. While five symbols are shown in this illustration, it is to be understood that in different embodiments, the total number of symbols may be greater or fewer.

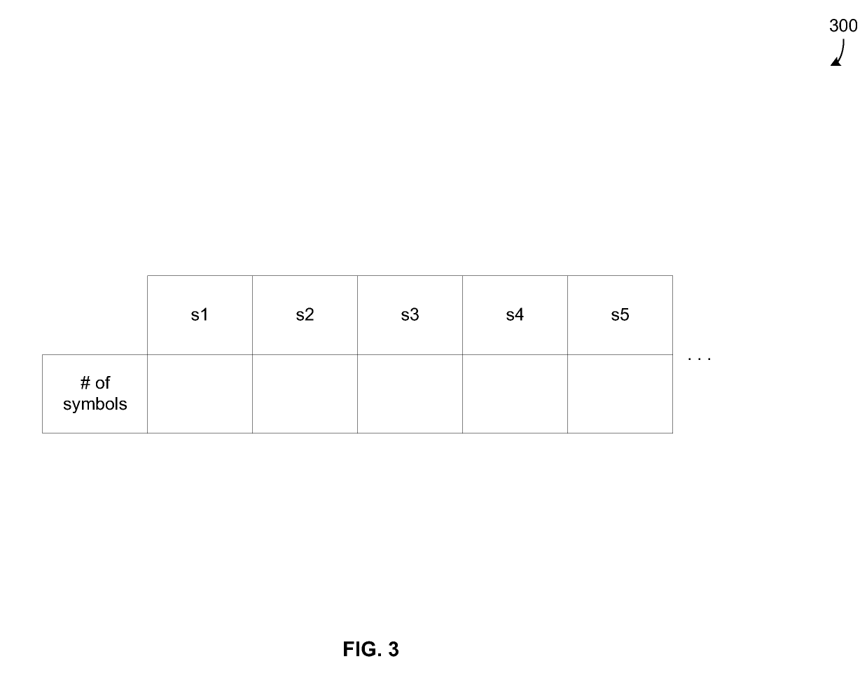

For purposes of processing, a histogram may be created and stored in the form of an array or similar data structure, according to an embodiment. Such an array is shown in FIG. 3. In this example, each element indicates the number of occurrences of a symbol in the previous frame, where the elements may be indexed by symbol identifiers.

One or more features disclosed herein may be implemented in hardware, software, firmware, or combinations thereof, including discrete and integrated circuit logic, application specific integrated circuit (ASIC) logic, programmable gate arrays, and/or microcontrollers, or may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein.

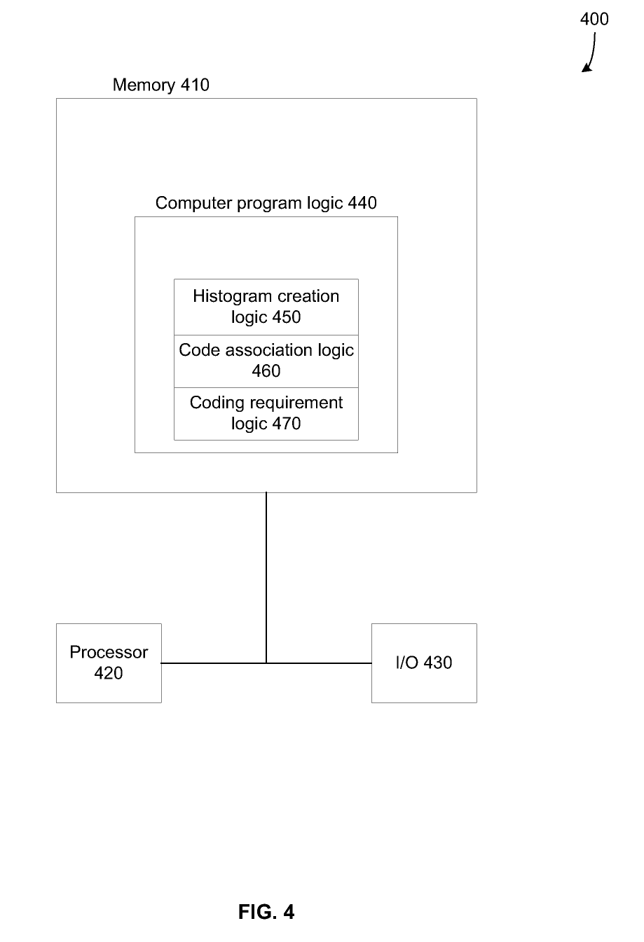

A software or firmware embodiment is illustrated in the context of a computing system 400 in FIG. 4. System 400 may include a processor 420 and a body of memory 410 that may include one or more computer readable media that may store computer program logic 440. Memory 410 may be implemented as a hard disk and drive, a removable media such as a compact disk and drive, or a read-only memory (ROM) or random access memory (RAM) device, for example. Processor 420 and memory 410 may be in communication using any of several technologies known to one of ordinary skill in the art, such as a bus. Computer program logic 440 contained in memory 410 may be read and executed by processor 420. One or more I/O ports and/or I/O devices, shown collectively as I/O 430, may also be connected to processor 420 and memory 410.

Computer program logic 440 may include histogram creation logic 450. This logic may be responsible for examination of a previous frame to determine the symbols used in that frame given a coding parameter M, counting the number of occurrences of each symbol, and construction of a histogram that captures this data. Computer program logic 440 may also comprise code association logic 460, which may be responsible for associating codes with the symbols used in the previous frame, given coding parameter M. As discussed above, the shortest code may be assigned to the symbol that occurred most frequently in the previous frame, the next shortest code may be assigned to the symbol that occurred with the next highest frequency, etc. Computer program logic 440 may also comprise coding requirement logic 470, which may be responsible for determining the total number of bits required to encode the previous frame, given a coding parameter M and the association between codes and the respective symbols.

In alternative embodiments, the computer program logic 440 may be organized differently in order to implement the processing described herein. Different logic modules may be used instead of those shown in FIG. 4. Moreover, in alternative embodiments, more or fewer logic modules may be used, as would be understood by those of ordinary skill in the art.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method, comprising:
creating a histogram of a previous frame, wherein the histogram indicates the number of occurrences of each of a plurality of symbols used to represent the previous frame using a coding parameter;
associating a code with each symbol, such that the code having the lowest number of bits is associated with the symbol having the most occurrences, and codes with successively greater numbers of bits are associated with respective symbols having successively fewer occurrences;
determining the number of bits needed to code the previous frame using the symbols and associated codes;
repeating said creation, association, and determination for each of a plurality of coding parameters; and
identifying the coding parameter that allows coding of the previous frame in a manner requiring the fewest bits.

2. The method of claim 1, further comprising:
using the identified coding parameter in compression of a current frame.

3. The method of claim 2, wherein the codes associated with the plurality of respective symbols comprise Golomb codes, and said compression comprises Golomb-Rice compression.

4. The method of claim 1, further comprising:
ordering the histogram from the most common symbol to the least common symbol.

5. The method of claim 1, wherein said method is performed on a system-on-a-chip (SOC) architecture.

6. The method of claim 1, wherein the plurality of coding parameters comprises eight coding parameters.

7. A system, comprising:
a processor; and
a memory in communication with said processor, said memory for storing a plurality of
processing instructions for directing said processor to
create a histogram of a previous frame, wherein the histogram indicates the number of occurrences of each of a plurality of symbols used to represent the previous frame using a coding parameter;
associate a code with each symbol, such that the code having the lowest number of bits is associated with the symbol having the most occurrences, and codes with successively greater numbers of bits are associated with respective symbols having successively fewer occurrences;
determine the number of bits needed to code the previous frame using the symbols and associated codes;
repeat said creation, association, and determination for each of a plurality of coding parameters; and
identify the coding parameter that allows coding of the previous frame in a manner requiring the fewest bits.

8. The system of claim 7, wherein said memory further stores processing instructions for directing said processor to
use the identified coding parameter in compression of a next frame.

9. The system of claim 8, wherein said codes associated with the plurality of respective symbols comprise Golomb codes, and said compression comprises Golomb-Rice compression.

10. The system of claim 7, wherein said memory further stores processing instructions for directing said processor to
order the histogram from the most common symbol to the least common symbol.

11. The system of claim 7, wherein said system is incorporated in a system-on-a-chip (SOC) architecture.

12. The system of claim 7, wherein said plurality of coding parameters comprises eight coding parameters.

13. A computer program product including a computer readable medium having computer program logic stored therein, the computer program logic comprising:
logic to cause a processor to create a histogram of a previous frame, wherein the histogram indicates the number of occurrences of each of a plurality of symbols used to represent the previous frame using a coding parameter;
logic to cause the processor to associate a code with each symbol, such that the code having the lowest number of bits is associated with the symbol having the most occurrences, and codes with successively greater numbers of bits are associated with respective symbols having successively fewer occurrences;
logic to cause the processor to determine the number of bits needed to code the previous frame using the symbols and associated codes;
logic to cause the processor to repeat said creation, association, and determination for each of a plurality of coding parameters; and
logic to cause the processor to identify the coding parameter that allows coding of the previous frame in a manner requiring the fewest bits.

14. The computer program product of claim 13, the computer program logic further comprising:
logic to cause the processor to use the identified coding parameter in compression of a next frame.

15. The computer program product of claim 14, wherein the codes associated with the plurality of respective symbols comprise Golomb codes, and the compression comprises Golomb-Rice compression.

16. The computer program product of claim 13, the computer program logic further comprising:
logic to cause the processor to order the histogram from the most common symbol to the least common symbol.

17. The computer program product of claim 13, wherein said computer program product is incorporated in a system-on-a-chip (SOC) architecture.

18. The computer program product of claim 13, wherein the plurality of coding parameters comprises eight coding parameters.
